(19) United States
(12) Patent Application Publication
(10) Pub. No.: US 2014/0218920 A1
(43) Pub. Date: Aug. 7, 2014

(54) Lighting Device

(71) Applicants: Kabushiki Kaisha Toshiba, Tokyo (JP); Toshiba Lighting & Technology Corporation, Yokosuka-shi (JP)

(72) Inventors: Junya Hayashi, Yokosuka-shi (JP); Hideki Okawa, Yokosuka-shi (JP); Hiroshi Kamata, Yokosuka-shi (JP); Yoshimasa Takahashi, Yokosuka-shi (JP)

(73) Assignees: KABUSHIKI KAISHA TOSHIBA, Tokyo (JP); TOSHIBA LIGHTING & TECHNOLOGY CORPORATION, Yokosuka-shi (JP)

(21) Appl. No.: 14/029,880

(22) Filed: Sep. 18, 2013

(30) Foreign Application Priority Data
Feb. 1, 2013 (JP) 2013-018974

(51) Int. Cl. F21V 15/015; F21V 31/00

(52) U.S. Cl. CPC F21V 15/015; F21V 31/00
USPC 362/249.01; 362/375

(57) ABSTRACT

According to one embodiment, a lighting device is provided which includes: a module; a first cover member; and a second cover member. The module has a light emitting body and a frame. The light emitting body emits light by organic electro-luminescence. The frame is formed of a light transmitting material. The first cover member is formed of a material that is a light transmitting material and has a stiffness higher than that of the frame. The first cover member is disposed on one end side of the module. The second cover member is formed of a material that is a light transmitting material and has a stiffness higher than that of the frame. The second cover member is disposed on the other end side of the module such that the module is sandwiched between the first cover member and the second cover member.

### CROSS-REFERENCE TO RELATED APPLICATIONS

This application is based upon and claims the benefit of priority from Japanese Patent Application No. 2013-018974, filed on Feb. 1, 2013; the entire contents of which are incorporated herein by reference.

### FIELD

Embodiments described herein relate generally to a lighting device.

### BACKGROUND

As a light source of a lighting device, it is conceivable to use an Organic Light-Emitting Diode (OLED) of which a light emitting surface itself emits light. For example, when Indium Tin Oxide (ITO) which is used for a transparent electrode is used for an electrode, an organic light-emitting diode panel (a transparent OLED panel) is obtained which is transparent when off-lighting is obtained. In addition, when a plurality of transparent OLED panels are assembled, it is possible to form an OLED lighting device which is transparent when off-lighting.

However, for the OLED, there are problems that strength is relatively low and handling is difficult. When the OLED is used for the lighting device, improvement in strength or ease of the handling is required.

### BRIEF DESCRIPTION OF THE DRAWINGS

FIGS. 1A to 1C are schematic views illustrating a lighting attached table in which a lighting device according to an embodiment is included.

FIG. 2 is an enlarged schematic view of region A1 illustrated in FIG. 1B.

FIGS. 3A and 3B are schematic views illustrating a module of the embodiment.

FIGS. 4A to 4C are schematic views illustrating a panel of the embodiment.

FIGS. 5A to 5C are schematic cross-sectional views illustrating the panel and the module of the embodiment.

FIGS. 6A and 6B are schematic cross-sectional views illustrating the module of the embodiment.

FIGS. 7A and 7B are schematic views illustrating an example of electrical connection of the embodiment.

### DETAILED DESCRIPTION

According to a first exemplary embodiment, there is provided a lighting device including: a module including a light emitting body which emits light by organic electro-luminescence and a frame which is formed of a light transmitting material and seals the light emitting body; a first cover member which is formed of a material that is a a light transmitting material and has a stiffness higher than that of the frame, and is disposed on one end side of the module; and a second cover member which is formed of a material that is a light transmitting material and has a stiffness higher than that of the frame, and is disposed on the other end side of the module such that the module is sandwiched between the first cover member and the second cover member.

According to a second exemplary embodiment, in the lighting device according to the first exemplary embodiment, the module has an outer peripheral section on which waterproofing treatment is performed.

According to a third exemplary embodiment, in the lighting device according to the second exemplary embodiment, the frame includes a first frame body including a concave section in which the light emitting body is disposed and a second frame body provided on the first frame body and covering the light emitting body, and the waterproofing treatment is provided such that a gasket having waterproof property is sandwiched between the first frame body and the second frame body.

According to a fourth exemplary embodiment, in the lighting device according to the first exemplary embodiment, detachment of the module is performed by detaching at least one of the first cover member and the second cover member.

According to a fifth exemplary embodiment, the lighting device according to the first exemplary embodiment, further includes: an outer member which fixes a peripheral portion of the first cover member and a peripheral portion of the second cover member to each other; and an elastic body having waterproof property which is provided between the outer member, and the first cover member, the second cover member and the module.

According to a sixth exemplary embodiment, in the lighting device according to the fifth exemplary embodiment, the outer member includes a base section, a first side section which is connected to a first end section of the base section and is bent with respect to a surface of the base section at a right angle when viewing the outer member in the longitudinal direction, and a second side section which is connected to a second end section of the base section which is different from the first end section and is bent with respect to the surface of the base section at a right angle when viewing the outer member in the longitudinal direction, in which the peripheral portion of the first cover member and the peripheral portion of the second cover member are disposed in a space between the first side section and the second side section and are fixed to each other.

According to a seventh exemplary embodiment, in the lighting device according to the fifth exemplary embodiment, the elastic body includes at least one of silicone and ethylene-propylene rubber.

According to an eighth exemplary embodiment, in the lighting device according to the fifth exemplary embodiment, a thickness of the elastic body disposed between the first cover member and the outer member is thinner than that of the elastic body disposed between the second cover member and the outer member.

According to a ninth exemplary embodiment, in the lighting device according to the first exemplary embodiment, the light emitting body transmits light when off-lighting.

According to a tenth exemplary embodiment, in the lighting device according to the first exemplary embodiment, the light emitting body includes: a substrate formed of a light transmitting material; a first electrode provided on the substrate and supplying a voltage to the panel; a second electrode provided on the substrate and supplying a voltage to the panel; a first conductive body which has conductivity, is connected to the first electrode and is provided on a first side surface of the substrate; and a second conductive body which has conductivity, is connected to the second electrode and is provided on a second side surface of the substrate.

According to an eleventh exemplary embodiment, in the lighting device according to the tenth exemplary embodiment, the first conductive body includes at least one of metal paste, carbon paste, conductive tape and a solder material.

According to a twelfth exemplary embodiment, in the lighting device according to the tenth exemplary embodiment, the second conductive body includes at least one of metal paste, carbon paste, conductive tape and a solder material.

According to a thirteenth exemplary embodiment, in the lighting device according to the tenth exemplary embodiment, the first electrode includes indium tin oxide.

According to a fourteenth exemplary embodiment, in the lighting device according to the tenth exemplary embodiment, the second electrode includes indium tin oxide.

According to a fifteenth exemplary embodiment, the lighting device according to the tenth exemplary embodiment, further includes: a connection body having conductivity, in which a plurality of light emitting bodies are provided, in which the plurality of light emitting bodies are electrically connected to each other by the first conductive body, the second conductive body and the connection body.

According to a sixteenth exemplary embodiment, in the lighting device according to the fifteenth exemplary embodiment, the connection body includes at least one of metal paste, carbon paste, conductive tape and a solder material.

According to a seventeenth exemplary embodiment, in the lighting device according to the fifteenth exemplary embodiment, the frame includes a first frame body including a concave section in which the light emitting body is disposed and a second frame body provided on the first frame body and covering the light emitting body, in which the connection body is provided on a side wall of the concave section and on a bonding surface between the first frame body and the second frame body.

According to an eighteenth exemplary embodiment, in the lighting device according to the fifteenth exemplary embodiment, further includes: a third conductive body provided between the first conductive body and the connection body; and a fourth conductive body provided between the second conductive body and the connection body, in which the first conductive body is electrically connected to the connection body via the third conductive body, and the second conductive body is electrically connected to the connection body via the fourth conductive body.

According to a nineteenth exemplary embodiment, in the lighting device according to the eighteenth exemplary embodiment, the third conductive body includes at least one of metal paste, carbon paste, conductive tape and a solder material.

According to a twentieth exemplary embodiment, in the lighting device according to the eighteenth exemplary embodiment, the fourth conductive body includes at least one of metal paste, carbon paste, conductive tape and a solder material.

Hereinafter, an exemplary embodiment will be described with reference to the drawings. In addition, the same reference numerals are given to the same configuration elements in each drawing and detailed description thereof will be omitted reasonably.

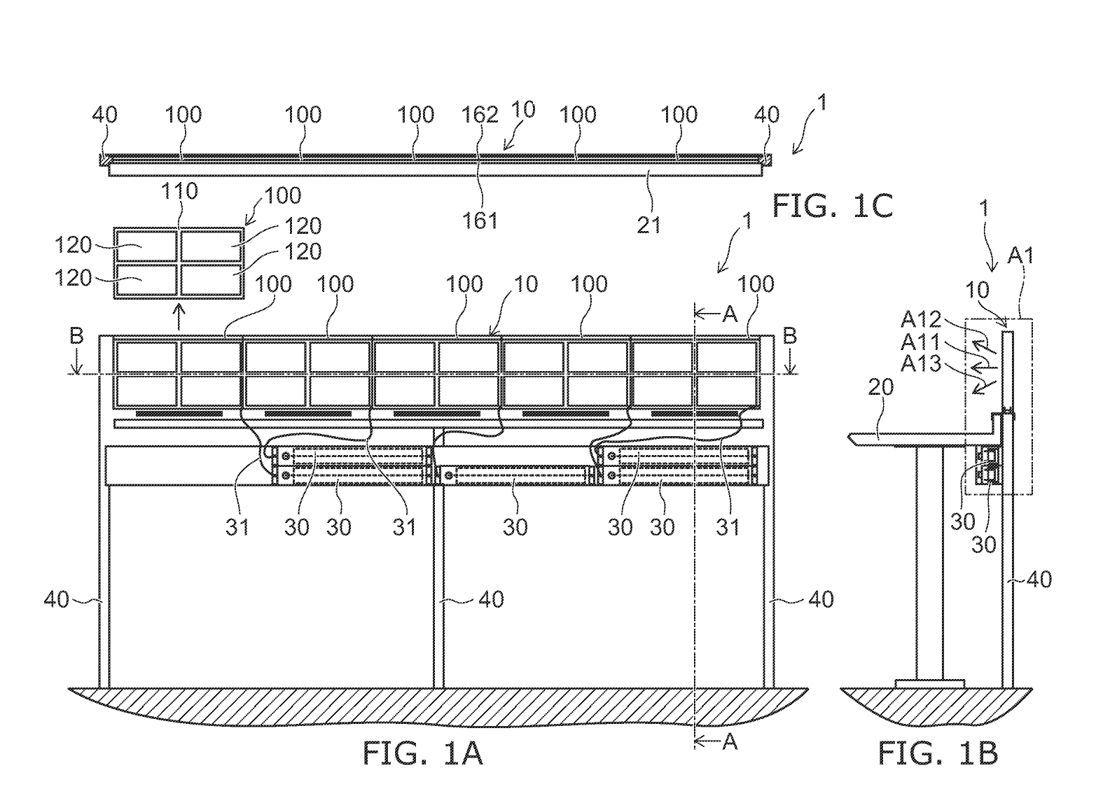

FIGS. 1A to 1C are schematic views illustrating a lighting attached table in which a lighting device according to an exemplary embodiment is included.

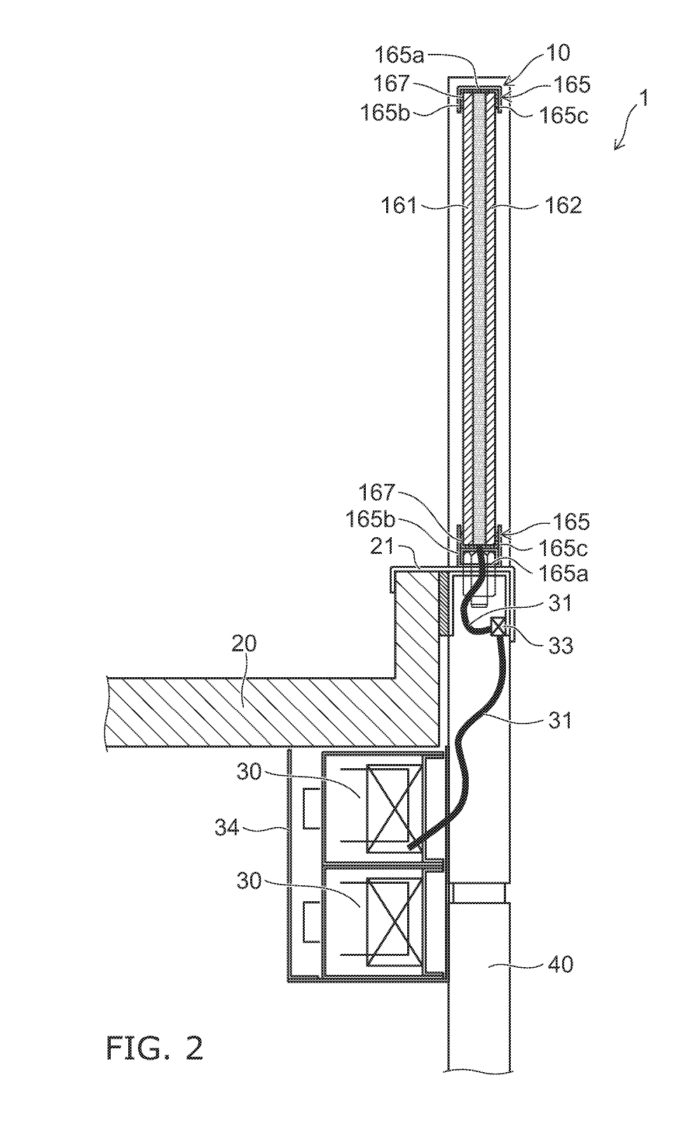

FIG. 2 is a schematic enlarged view of region A1 illustrated in FIG. 1B.

FIG. 1A is a schematic plan view illustrating the lighting attached table in which the lighting device according to the embodiment is included. FIG. 1B is a schematic cross-sectional view in cutting plane A-A illustrated in FIG. 1A. FIG. 1C is a schematic cross-sectional view in cutting plane B-B illustrated in FIG. 1A. A table 20 is omitted in FIG. 1C.

A lighting device 10 according to the embodiment is used, for example, by being attached to a table. Otherwise, the lighting device 10 according to the embodiment is used, for example, by being attached to a show window, a show case or the like. Otherwise, the lighting device 10 according to the embodiment is used by being attached to a ceiling window or the like. As described above, the lighting device 10 according to the embodiment is used in variety of applications.

Hereinafter, a case where the lighting device 10 according to the embodiment is attached to the table will be described as an example.

A lighting attached table 1 illustrated in FIGS. 1A to 2 includes the lighting device 10, the table 20, a power supply unit 30 and a support member 40. As illustrated in FIG. 2, the lighting device 10 is fixed to the table 20 by a fixing member 21. One end portion of the table 20 has an L-shape. In other words, one end portion of the table 20 is bent substantially at a right angle. The lighting device 10 is fixed by the fixing member 21 to the front end portion of the L-shape via an elastic member such as a gasket. In addition, the lighting device 10 is supported by the support member 40. In addition, when the lighting device 10 can be supported only by the fixing member 21, the support member 40 may not be necessary to provide. The lighting device 10 has a module 100 in which a panel (a light emitting body) 120 is sandwiched and sealed in a frame 110.

The frame 110 is formed of a resin capable of transmitting light (for example, acrylic or polycarbonate or the like capable of transmitting light).

In the specification of this application, the expression “capable of transmitting light” or “transmitting light” is not limited to 100% of transmittance and says that the transmittance is not zero with respect to at least light having a wavelength of visible light.

The lighting device 10 illustrated in FIGS. 1A to 1C has a plurality of modules 100. In the embodiment, five modules 100 are disposed so as to be side by side and in close contact with each other. However, the lighting device 10 is not limited to having a plurality of modules 100 but may have one module 100. As illustrated in FIG. 1A, for example, the module 100 has four panels 120. However, the module 100 is not limited to having four panels 120 but may have a plurality of or one panel 120. Hereinafter, a case where the module 100 has four panels 120 will be described as an example.

The module 100 is connected to the power supply unit 30 via a power supply line 31. For example, as illustrated in FIG. 2, the power supply line 31 connected to the module 100 is connected to the power supply line 31 which is connected to the power supply unit 30 via a connector 33. The power supply unit 30 is disposed in an accommodation case 34. The power supply unit 30 may be disposed in a space which is divided by a part (here, a back surface (a lower surface) of the table 20) of the table 20 and the accommodation case 34. According to such a structure, the power supply unit 30 is maintained further safely without contact with a user. When replacement of the power supply unit 30 is required, it is possible to perform replacement work more easily. When the power supply unit 30 supplies a voltage to the panel 120 via the power supply line 31, for example, as illustrated in an arrow direction A11, an arrow direction A12 and an arrow direction A13 in FIG. 1B, the panel 120 mainly radiates light toward the table 20 side. In other words, the panel 120 mainly radiates light to one surface side (the table 20 side in the embodiment) when lighting. In addition, the plurality of panels 120 are connected to each other in series. This will be described in detail later.

The panel 120 is a sheet-shaped panel emitting light by organic electro-luminescence (OEL) and includes an organic light-emitting diode (OLED) panel which is transparent when off-lighting, that is, the diode through which the opposite side of panel 120 can be seen. Thus, light passes through the panel 120 when the voltage is not supplied from the power supply unit 30 (when off-lighting).

As illustrated in FIG. 2, the lighting device 10 has the module 100, a first cover member 161, a second cover member 162, an outer member 165 and an elastic body 167. The second cover member 162 is provided to be spaced apart from the first cover member 161. The first cover member 161 is disposed on one end side (on the table 20 side in the embodiment) of the module 100. The second cover member 162 is disposed on the other end side (on the opposite side to the table 20 in the embodiment) of the module 100. The module 100 is sandwiched between the first cover member 161 and the second cover member 162. The module 100 and the panel 120 will be described in detail later.

The first cover member 161 and the second cover member 162 are formed of a glass capable of transmitting light, for example, a reinforced glass.

In the specification of this application, “the reinforced glass” is referred to as a glass having a compressive stress layer on a surface of the glass in addition to increased strength against an external force and temperature change, compared to a glass not having the compressive stress layer.

As described above, the frame 110 is formed of a resin capable of transmitting light. Considering the configuration, the stiffness of the first cover member 161 and the second cover member 162, respectively is higher than the stiffness of the module 100, for example, higher than the stiffness of a material of the frame 110.

In the specification of this application, “the stiffness” is, for example, referred to as elasticity with regards to “twist”, “deviation” or the like and means resistance property against deformation when an object is deformed by receiving an external force. It is preferable that the first cover member 161 and the second cover member 162 have a property such that scarring by “scratching” or the like is less likely to occur than the module 100, for example, the material of the frame 110.

Peripheral portions of the first cover member 161 and the second cover member 162 are fixed to each other by the outer member 165 in a state where the module 100 is sandwiched between the first cover member 161 and the second cover member 162. For example, the outer member 165 is formed of metal. As illustrated in FIG. 1A, when an entire external shape of a plurality of modules 100, the first cover member 161 and the second cover member 162 are square shapes (rectangular shapes in the embodiment), the outer member 165 is provided at four external sides of the first cover member 161 and the second cover member 162.

As illustrated in FIG. 2, the outer member 165 of the embodiment has a base section 165a, a first side section 165b and a second side section 165c. When viewing the outer member 165 in the longitudinal direction, the first side section 165b is connected to an end portion of the base section 165a and is bent substantially at a right angle with respect to a main surface of the base section 165a. The second side section 165c is connected to the other end portion (an end portion of the opposite side to the end portion to which the first side section 165b is connected) of the base section 165a and is bent substantially at a right angle with respect to the main surface of the base section 165a. The outer member 165 can accommodate the first cover member 161 and the second cover member 162 in a space (an inner space) between the base section 165a, the first side section 165b and the second side section 165c. In other words, the peripheral portion of the first cover member 161 and the peripheral portion of the second cover member 162 are disposed and fixed to each other in the inner space formed by the outer member 165 in a state where the module 100 is sandwiched between the first cover member 161 and the second cover member 162.

The elastic body 167 is provided between the first cover member 161, the second cover member 162, and the module 100, and the outer member 165. The elastic body 167 is a gasket with which a gap is filled between the first cover member 161, the second cover member 162, and the module 100, and the outer member 165 and is formed of a material having waterproof property. In addition, the elastic body 167 is formed of an independent single-bubble sponge. The material of the elastic body 167 may include, for example, silicone or ethylene propylene rubber (EPT) or the like.

Furthermore, in the embodiment, the thickness of the elastic body 167 of the first cover member 161 side may be thinner than the thickness of the elastic body 167 of the second cover member 162 side. Therefore, it is possible to suppress a relatively large difference in level from occurring between the first side section 165b and the first cover member 161 by the thickness of the elastic body 167 in the table 20 side which is visible to the user and suppress an external appearance defect while ensuring elasticity to exhibit a holding sufficient elasticity.

When the first cover member 161, the second cover member 162 and the module 100 are assembled, first, the first cover member 161 and the second cover member 162 are disposed in the space inside the outer member 165. At this time, the outer member 165 disposed on an upper portion of the lighting device 10 is not provided yet. Sequentially, the module 100 is forcibly inserted between the first cover member 161 and the second cover member 162. Therefore, the elastic body 167 is compressed by the first cover member 161 and the second cover member 162 and can ensure the waterproof property.

On the other hand, for example, when the module 100 is detached for replacement work or the like of the module 100, since the module 100 is forcibly inserted between the first cover member 161 and the second cover member 162, it is difficult to detach the module 100 as it is. In contrast, in the embodiment, first, one of a plurality of outer members 165, for example, the outer member 165 of the upper portion or the side portion, that is, portions other than the outer member 165 of the lower portion, is detached and then at least one of the first cover member 161 and the second cover member 162 is detached. Surfaces of the first cover member 161 and the second cover member 162, opposite to the module 100 are open, respectively. Thus, detaching work of at least one of the first cover member 161 and the second cover member 162 is easier than the detaching work of the module 100 which is sandwiched between the first cover member 161 and the second cover member 162. In addition, even though one of the first cover member 161 and the second cover member 162 is detached, the other one of the first cover member 161 and the second cover member 162, and the module 100 are supported by the outer member 165. Thus, there is no concern that the other one of the first cover member 161 and the second cover member 162, and the module 100 fall off or the like. Substantially, after at least one of the first cover member 161 and the second cover member 162 is detached, the module 100 is detached.

According to the embodiment, since the module 100 is sandwiched between the first cover member 161 and the second cover member 162 and since the stiffness of the first cover member 161 and the second cover member 162, respectively, is higher than the stiffness of the module 100, it is possible to protect the panel 120. In addition, it is possible to withstand an external force which is applied when maintenance work such as cleaning work is performed. Therefore, it is possible to improve strength of the lighting device 10 and to facilitate handling.

In addition, it is possible to easily detach the module 100 by detaching at least one of the first cover member 161 and the second cover member 162. Thus, it is possible to easily perform replacement work of the module 100.

In addition, since the lighting device 10 is attached to the L-shaped front end portion of the table 20, it is possible to easily attach and detach the lighting device 10 itself.

In addition, the elastic body 167 having the waterproof property is provided between the first cover member 161, the second cover member 162, and the module 100, and the outer member 165. Thus, it is possible to suppress moisture from entering between the first cover member 161 and the second cover member 162. Therefore, it is possible to protect the panel 120 from moisture.

Furthermore, the panel 120 transmits light when off-lighting. Thus, it is possible to suppress daylight from being blocked during bright daytime and to suppress a side of an irradiation surface (a surface which radiates light) from being darkened by assembling the module 100 (the frame 110) capable of transmitting light, the cover members (the first cover member 161 and the second cover member 162) capable of transmitting light and the panel 120.

On the other hand, when the ambiance is dark, it is possible to irradiate light in a desired range by lighting the panel 120. In the embodiment, the panel 120 emits the light substantially only on the first cover member 161 side. Thus, it is possible to supply light only to the table 20 side for which light is necessary when lighting the panel 120.

Furthermore, in the panel 120 capable of transmitting light as in the embodiment, because of the structure of panel 120, a color shift can occur easily depending on a viewing direction. On the other hand, in the embodiment, it is possible to expect a phenomenon of a suppressing effect on such color shift dependent on the viewing direction by interposing the panel 120 between the cover members or the like.

Next, the module 100 and the panel 120 will be described with reference to the drawings.

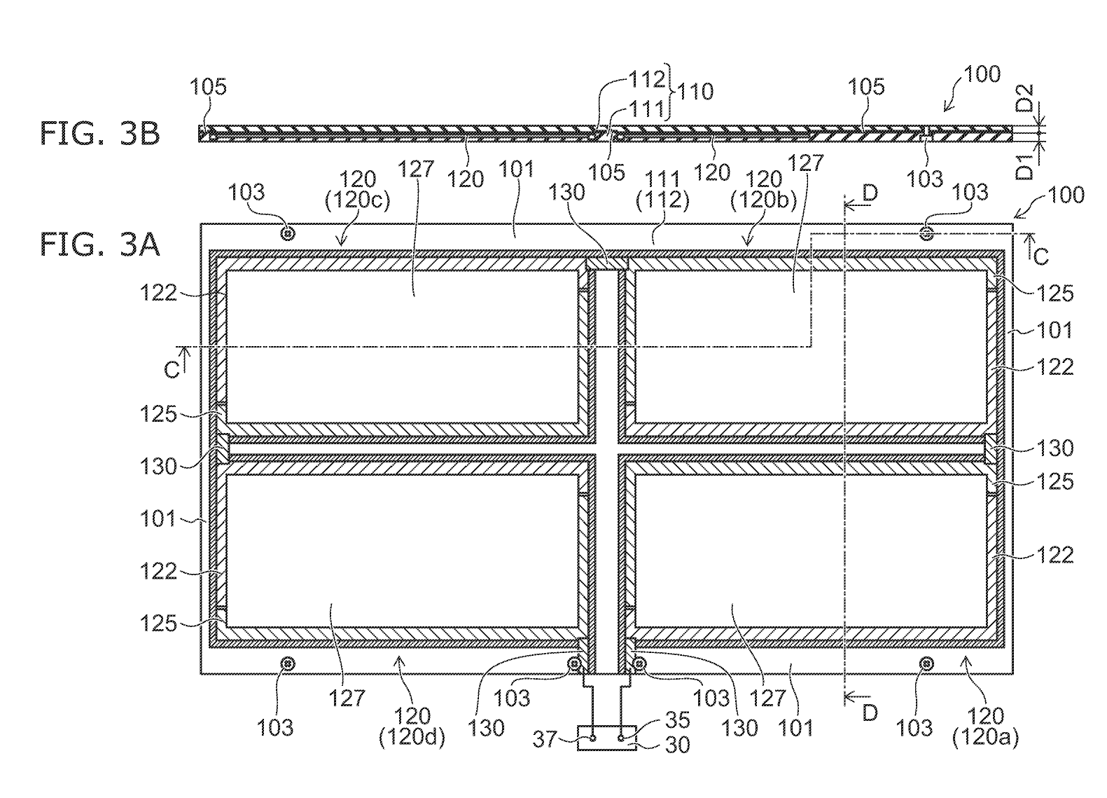

FIGS. 3A and 3B are schematic views illustrating the module of the embodiment.

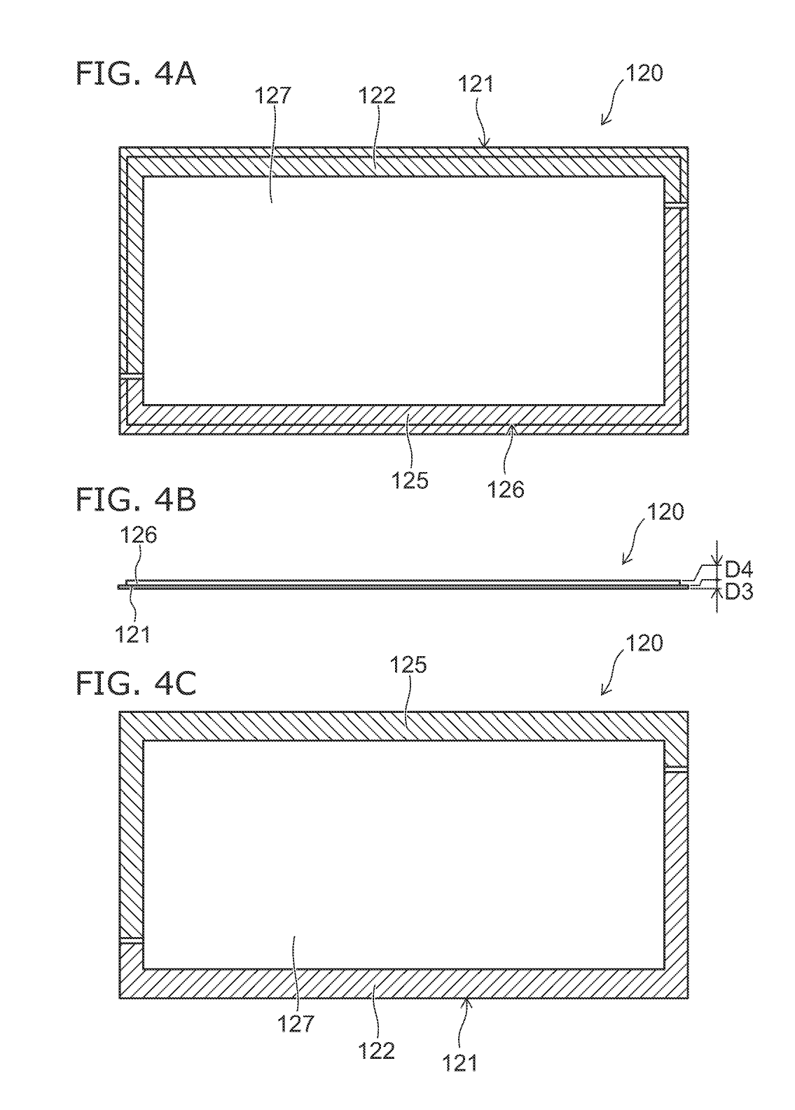

FIGS. 4A to 4C are schematic views illustrating the panel of the embodiment.

FIG. 3A is a schematic plan view illustrating the module of the embodiment. FIG. 3B is a schematic cross-sectional view taken in cutting plane C-C illustrated in FIG. 3A. FIG. 4A is a schematic plan view of the panel of the embodiment viewed from a power supply side. FIG. 4B is a schematic plan view of the side surface of the panel of the embodiment viewed in a vertical direction. FIG. 4C is a schematic plan view of the panel of the embodiment viewed from a light emitting side.

The module 100 of the embodiment has the frame 110, the panel 120 and a connection body 130. As illustrated in FIG. 3B, the frame 110 has a first frame body 111 and a second frame body 112. The frame 110 is formed of an insulating material that is capable of transmitting the light (for example, acrylic or polycarbonate or the like capable of transmitting light). The thickness (the length in the vertical direction in FIG. 3B) D1 of the first frame body 111 is, for example, approximately 3 mm or more and 5 mm or less. The thickness (the length in the vertical direction in FIG. 3B) D2 of the second frame body 112 is, for example, approximately 2 mm or more and 4 mm or less.

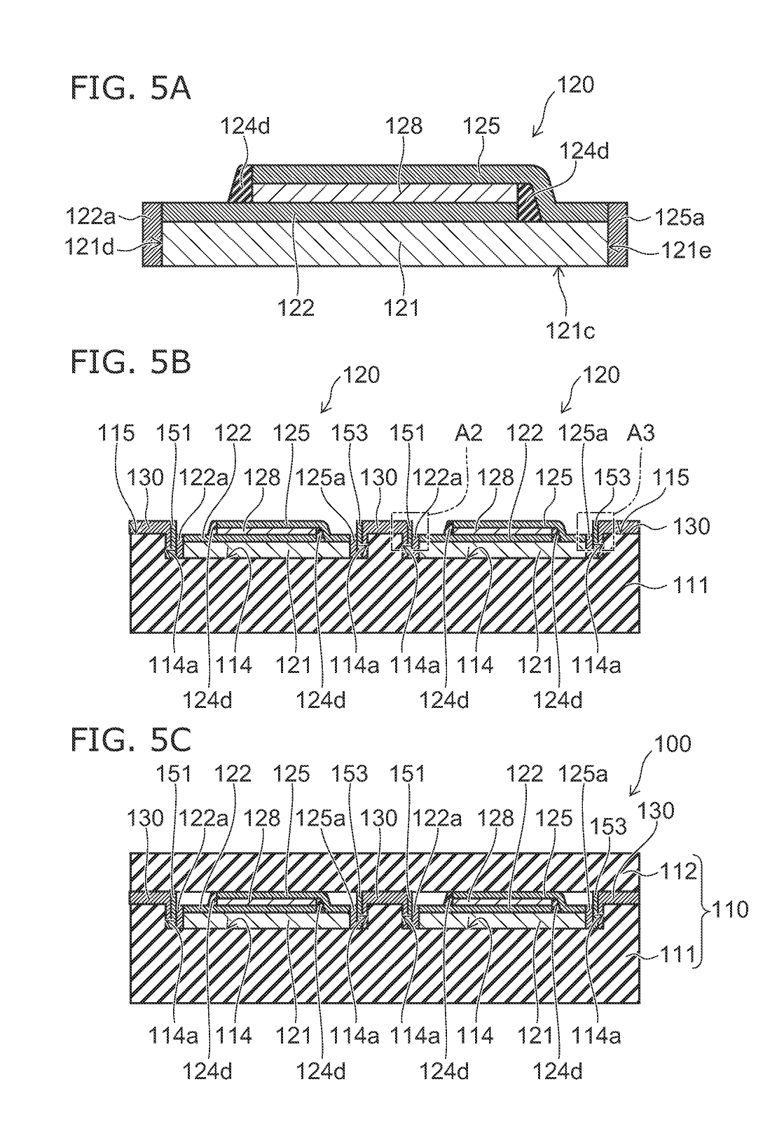

The module 100 has a structure in which a plurality of panels 120 are sandwiched and sealed between the first frame body 111 and the second frame body 112. Specifically, the first frame body 111 has a concave section 114 (see FIGS. 5B and 5C). The depth of the concave section 114 is substantially the same as the thickness of the panel 120. The panel 120 is disposed in the concave section 114 provided in the first frame body 111. For example, the concave section 114 is formed in the first frame body 111 by cutting a flat plate.

Waterproofing treatment is applied to an outer peripheral section 101 of the module 100. Specifically, the first frame body 111 and the second frame body 112 are fastened to each other by a fastening member 103 (for example, screw or the like) in a state where a waterproofing gasket 105 (see FIG. 3B) is sandwiched between the first frame body 111 and the second frame body 112. Otherwise, the first frame body 111 and the second frame body 112 may be bonded by a waterproofing adhesive in the outer peripheral section 101. Otherwise, caulking may be provided in a bonding section between the first frame body 111 and the second frame body 112.

Waterproofing treatment is not necessary to be applied in locations other than the module 100 in the lighting device 10 and it is possible to simplify the structure of the lighting device 10 by applying the waterproofing treatment in the outer peripheral section 101 of the module 100.

As illustrated in FIGS. 4A and 4C, the panel 120 has a first substrate 121, a first electrode 122, a second electrode 125 and a second substrate 126. Each of the first substrate 121 and the second substrate 126 are formed of a transparent material (for example, a glass or a resin material capable of transmitting light). The thickness (the length in the vertical direction in FIG. 4B) D3 of the first substrate 121 is approximately 2 mm or less. For example, the thickness D3 of the first substrate 121 is approximately 0.6 mm or more and 0.8 mm or less. The thickness (the length in the vertical direction in FIG. 4B) D4 of the second substrate 126 is approximately 2 mm or less. For example, the thickness D4 of the second substrate 126 is approximately 0.6 mm or more and 0.8 mm or less.

FIGS. 5A to 5C are schematic cross-sectional views illustrating the panel and the module of the embodiment.

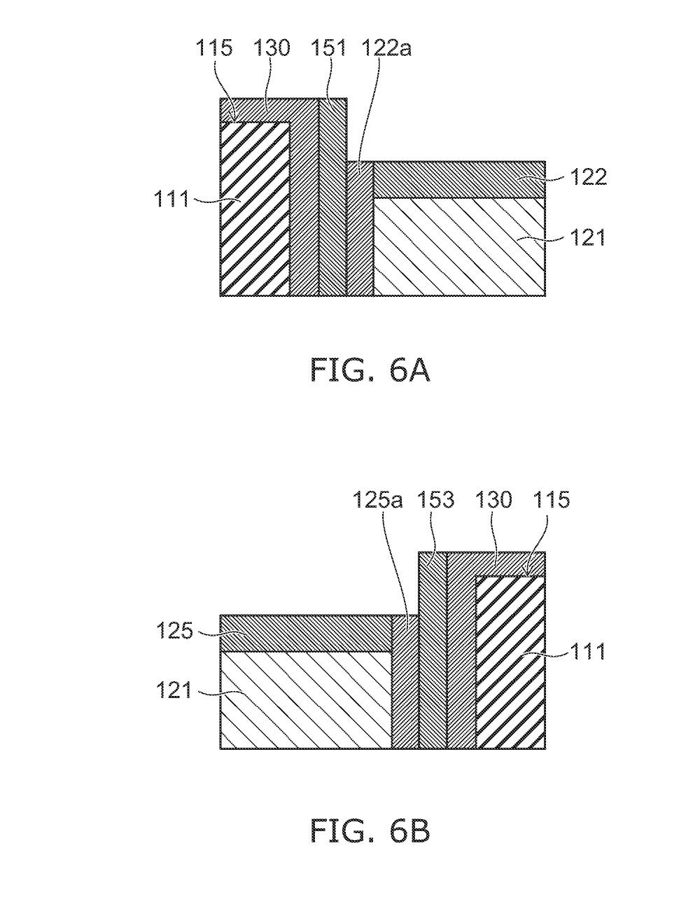

FIGS. 6A and 6B are schematic cross-sectional views illustrating the module of the embodiment.

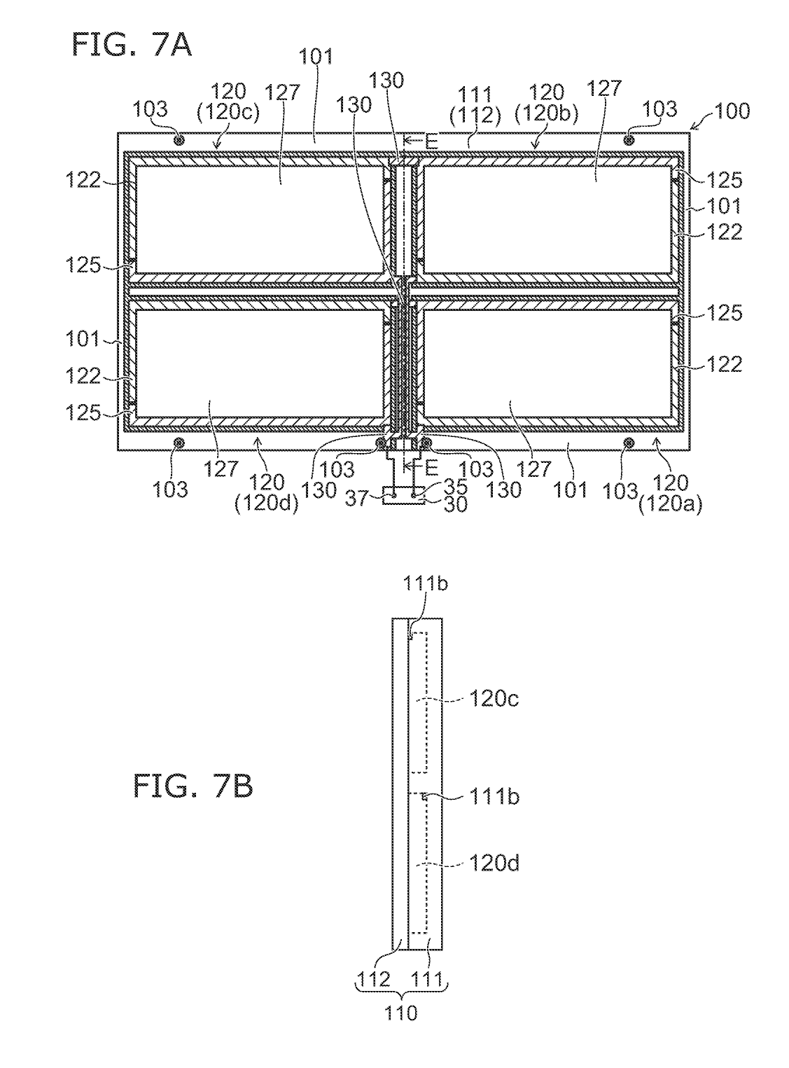

FIGS. 7A and 7B are schematic views illustrating an example of an electrical connection of the embodiment.

FIG. 5A is a schematic cross-sectional view illustrating the panel of the embodiment in cutting plane D-D illustrated in FIG. 3A. FIGS. 5B and 5C are schematic cross-sectional views illustrating the module of the embodiment in the cutting plane D-D illustrated in FIG. 3A. FIG. 6A is a schematic enlarged view of region A2 illustrated in FIG. 5B. FIG. 6B is a schematic enlarged view of region A3 illustrated in FIG. 5B. In addition, in the module and the panel illustrated in FIGS. 5A to 6B, the second substrate 126 is omitted. FIG. 7A is a schematic plan view illustrating an example of the electrical connection of the embodiment. FIG. 7B is a schematic cross-sectional view in cutting plane E-E illustrated in FIG. 7A.

As illustrated in FIG. 5A, the panel 120 has an organic layer 128, a first conductive body 122a and a second conductive body 125a. At least a part of the organic layer 128 is provided between the first electrode 122 and the second electrode 125.

When the voltage is supplied through the first electrode 122 and the second electrode 125, the panel 120 can radiate light from a main surface 121c of the substrate 121 to the outside. In other words, the organic layer 128 emits light in a light emitting region 127 (see FIGS. 3A to 4C) and it is possible to radiate light from the main surface 121c of the first substrate 121 to the outside when the voltage is applied between the first electrode 122 and the second electrode 125. In addition, it is also possible not to nearly radiate light from the second electrode 125.

In the embodiment, the first electrode 122 is an anode electrode. At least a part of the first electrode 122 is formed of indium tin oxide (ITO) as a transparent conductive film. The first electrode 122 may have an auxiliary wiring (not illustrated) in which a plurality of layers are laminated. The auxiliary wiring (not illustrated) can spread the current, which cannot be spread in a surface that is formed only by a solid film, in the surface of the solid film, and it is possible to improve conductivity of the first electrode 122. The auxiliary wiring (not illustrated) can suppress uneven brightness in the surface of the panel 120.

In the embodiment, the second electrode 125 is a cathode electrode. The second electrode 125 is, for example, formed of a metal material such as aluminum (Al). In addition, the second electrode 125 may be formed of indium tin oxide (ITO) as the transparent conductive film, similar to the first electrode 122.

As illustrated in FIG. 5A, the first conductive body 122a is provided in a first side surface 121d of the substrate 121. The first conductive body 122a has conductivity and includes at least one of metal paste, carbon paste, conductive tape and a solder material. The first conductive body 122a is electrically connected to the first electrode 122.

As illustrated in FIG. 5A, the second conductive body 125a is provided in a second side surface 121e of the substrate 121. The second conductive body 125a has conductivity and includes at least one of the metal paste, the carbon paste, the conductive tape and the solder material. The second conductive body 125a is electrically connected to the second electrode 125.

An insulation layer 124d is provided between the first electrode 122 and the second electrode 125.

As illustrated in FIGS. 5B to 6B, the connection body 130 is provided in a side wall 114a of the concave section 114 in the first frame body 111 and an upper surface (the bonding surface of the first frame body 111 and the second frame body 112) 115 of the first frame body 111. The connection body 130 has conductivity and includes at least one of the metal paste, the carbon paste, the conductive tape and the solder material. In addition, the connection body 130 is not limited to the paste state or the tape shape and may include, for example, a wire material such as a generic lead wire.

In a state where the panel 120 is disposed in the concave section 114 in the first frame body 111, the connection body 130 is electrically connected to the first conductive body 122a via a third conductive body 151. The third conductive body 151 is provided between the first conductive body 122a and the connection body 130. In addition, in a state where the panel 120 is disposed in the concave section 114 in the first frame body 111, the connection body 130 is electrically connected to the second conductive body 125a via a fourth conductive body 153. The fourth conductive body 153 is provided between the second conductive body 125a and the connection body 130.

The third conductive body 151 and the fourth conductive body 153 include at least one of the metal paste, the carbon paste, the conductive tape and the solder material. The third conductive body 151 is provided with which a gap is filled between the first conductive body 122a and the connection body 130 after the panel 120 is disposed in the concave section 114 in the first frame body 111. The fourth conductive body 153 is provided with which a gap is filled between the second conductive body 125a and the connection body 130 after the panel 120 is disposed in the concave section 114 in the first frame body 111. In addition, the connection body 130 may be electrically connected to the first conductive body 122a and the second conductive body 125a, directly and respectively without passing through the third conductive body 151 and the fourth conductive body 153.

According to the embodiment, the panel 120 may be electrically connected to a power supply outside the frame 110 by the first conductive body 122a, the second conductive body 125a, the connection body 130, the third conductive body 151 and the fourth conductive body 153 in a state where the panel 120 is sandwiched and sealed between the first frame body 111 and the second frame body 112. In addition, a plurality of panels 120 may be electrically connected to each other by the first conductive body 122a, the second conductive body 125a, the connection body 130, the third conductive body 151 and the fourth conductive body 153 in a state where the panels 120 are sandwiched and sealed between the first frame body 111 and the second frame body 112. Thus, for example, it is possible to improve the electrical connection of the panels 120 while suppressing the thickness of the module 100, the frame 110, and the panel 120 without necessity to separately provide a special wiring, for example, such as a print wiring, that is, without damaging a fine appearance of the module 100 including the transparent frame 110. The effect thereof is significant in the module 100 transparently unified as a whole with the panel 120 of the embodiment that is light transmittable panel.

In addition, it is possible to protect the panel 120 and to suppress damage to the panel 120 by modularizing the panel 120. Therefore, it is possible to easily handle the panels 120 when a plurality of panels 120 are replaced.

Furthermore, since the panel 120 of which the thickness is suppressed is sealed in the frame 110, handling of the module 100 or electrical connection of a plurality of modules 100 becomes easier. Thus, it is possible to provide the transparent OLED lighting device 10 in a large size.

The first electrode 122 of a first panel 120a illustrated in FIGS. 3A and 3B is connected to an anode electrode 35 of the power supply unit 30 via the first conductive body 122a and the connection body 130. In the embodiment, since a plurality (for example, five sets) of similar modules 100 are disposed side by side, the power supply unit 30 is disposed below the module 100. In addition, as described above with reference to FIGS. 5B, 5C and 6A, the third conductive body 151 may be provided between the first conductive body 122a and the connection body 130.

Subsequently, the second electrode 125 of the first panel 120a is connected to the first electrode 122 of a second panel 120b via the second conductive body 125a, the connection body 130 and the first conductive body 122a. In addition, as described above with reference to FIGS. 5B, 5C and 6B, the fourth conductive body 153 may be provided between the second conductive body 125a and the connection body 130.

Subsequently, the second electrode 125 of the second panel 120b is connected to the first electrode 122 of a third panel 120c via the second conductive body 125a, the connection body 130 and the first conductive body 122a. Subsequently, the second electrode 125 of the third panel 120c is connected to the first electrode 122 of a fourth panel 120d via the second conductive body 125a, the connection body 130 and the first conductive body 122a. Subsequently, the second electrode 125 of the fourth panel 120d is connected to a cathode 37 of the power supply unit 30 via the second conductive body 125a and the connection body 130.

Accordingly, a series circuit is formed between the first panel 120a, the second panel 120b, the third panel 120c, the fourth panel 120d and the power supply unit 30. When the power supply unit 30 supplies the voltage to the module 100, the first panel 120a, the second panel 120b, the third panel 120c and the fourth panel 120d radiate light from the main surface 121c (see FIG. 5A) of the substrate 121 to the outside.

Furthermore, the aspect of the electrical connection illustrated in FIG. 3A is an example and the electrical connection of the embodiment is not limited to the aspect. For example, as illustrated in FIG. 7A, the first panel 120a and the fourth panel 120d connected to each other in series by the connection body 130 as well as the second panel 120b and the third panel 120c connected to each other in series by the connection body 130 may be connected to each other in parallel. In this case, as illustrated in FIG. 7B, the connection between the first panel 120a and the fourth panel 120d by the connection body 130 is performed via a through hole 111b formed in the first frame body 111. Therefore, the connection body 130 connecting the second panel 120b, the third panel 120c and the power supply unit 30 as well as the connection body 130 connecting the first panel 120a and the fourth panel 120d may be three-dimensionally intersected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting device comprising:
a module including a light emitting body which emits light by organic electro-luminescence and a frame which is formed of a light transmitting material and seals the light emitting body;
a first cover member which is formed of a material that is a light transmitting material and has a stiffness higher than that of the frame, and is disposed on one end side of the module; and
a second cover member which is formed of a material that is a light transmitting material and has a stiffness higher than that of the frame, and is disposed on the other end side of the module such that the module is sandwiched between the first cover member and the second cover member.

2. The device according to claim 1,
wherein the module has an outer peripheral section on which waterproofing treatment is performed.

3. The device according to claim 2,
wherein the frame includes a first frame body including a concave section in which the light emitting body is disposed and a second frame body provided on the first frame body and covering the light emitting body, and
wherein in the waterproofing treatment, a gasket having waterproof property is sandwiched between the first frame body and the second frame body.

4. The device according to claim 1,
wherein detachment of the module is performed by detaching at least one of the first cover member and the second cover member.

5. The device according to claim 1, further comprising:
an outer member which fixes a peripheral portion of the first cover member and a peripheral portion of the second cover member to each other; and
an elastic body having waterproof property which is provided between the outer member and the first cover member, the second cover member and the module.

6. The device according to claim 5,
wherein the outer member includes
a base section,
a first side section which is connected to a first end section of the base section and is bent with respect to a surface of the base section at a right angle when viewing the outer member in the longitudinal direction, and
a second side section which is connected to a second end section of the base section which is different from the first end section and is bent with respect to the surface of the base section at a right angle when viewing the outer member in the longitudinal direction, and
wherein the peripheral portion of the first cover member and the peripheral portion of the second cover member are disposed in a space between the first side section and the second side section and are fixed to each other.

7. The device according to claim 5,
wherein the elastic body includes at least one of silicone and ethylene-propylene rubber.

8. The device according to claim 5,
wherein the thickness of the elastic body disposed between the first cover member and the outer member is thinner than that of the elastic body disposed between the second cover member and the outer member.

9. The device according to claim 1,
wherein the light emitting body transmits light when off-lighting.

10. The device according to claim 1,
wherein the light emitting body includes
a substrate formed of a light transmitting material,
a first electrode provided on the substrate and supplying a voltage to the panel,
a second electrode provided on the substrate and supplying a voltage to the panel,
a first conductive body which has conductivity, is connected to the first electrode and is provided on a first side surface of the substrate, and
a second conductive body which has conductivity, is connected to the second electrode and is provided on a second side surface of the substrate.

11. The device according to claim 10,
wherein the first conductive body includes at least one of metal paste, carbon paste, conductive tape and a solder material.

12. The device according to claim 10,
wherein the second conductive body includes at least one of metal paste, carbon paste, conductive tape and a solder material.

13. The device according to claim 10,
wherein the first electrode includes indium tin oxide.

14. The device according to claim 10,
wherein the second electrode includes indium tin oxide.

15. The device according to claim 10, further comprising:
a connection body having conductivity,
wherein a plurality of light emitting bodies are provided, and
wherein the plurality of light emitting bodies are electrically connected to each other by the first conductive body, the second conductive body and the connection body.

16. The device according to claim 15,
wherein the connection body includes at least one of metal paste, carbon paste, conductive tape and a solder material.

17. The device according to claim 15,
wherein the frame includes a first frame body having a concave section in which the light emitting body is disposed and a second frame body provided on the first frame body and covering the light emitting body, and
wherein the connection body is provided on a side wall of the concave section and on a bonding surface between the first frame body and the second frame body.

18. The device according to claim 15, further comprising:
a third conductive body provided between the first conductive body and the connection body; and
a fourth conductive body provided between the second conductive body and the connection body,
wherein the first conductive body is electrically connected to the connection body via the third conductive body, and
wherein the second conductive body is electrically connected to the connection body via the fourth conductive body.

19. The device according to claim 18,
wherein the third conductive body includes at least one of metal paste, carbon paste, conductive tape and a solder material.

20. The device according to claim 18,
wherein the fourth conductive body includes at least one of metal paste, carbon paste, conductive tape and a solder material.
